(19) United States
(12) Patent Application Publication
(10) Pub. No.: US 2026/0179250 A1
(43) Pub. Date: Jun. 25, 2026

(54) METHOD AND APPARATUS FOR DETECTING GAZE POINT BASED ON CAMERA POSE RECOGNITION

(71) Applicant: ELECTRONICS AND TELECOMMUNICATIONS RESEARCH INSTITUTE, Daejeon (KR)

(72) Inventors: Jang Hee YOO, Daejeon (KR); Cheol Hwan YOO, Daejeon (KR); Sun Kyung LEE, Daejeon (KR); Jae Yoon JANG, Daejeon (KR)

(21) Appl. No.: 19/414,965

(22) Filed: Dec. 10, 2025

(30) Foreign Application Priority Data
Dec. 24, 2024 (KR) 10-2024-0195302

(51) Int. Cl. G06T 7/73

(52) U.S. Cl. CPC G06T 7/73; G06T 2207/10024; G06T 2207/10048; G06T 2207/30201; G06T 2207/30244

(57) ABSTRACT

In one embodiment, the system includes a camera, an analysis device, and a display. In one embodiment, an analysis device includes a processing unit; and a storage configured to store instructions that, when executed by the processing unit, cause the analysis device to perform operations that includes: acquiring user image and field of view information; estimating a gaze direction of a user based on the user image; calculating a distance between the camera and a detected face of the user based on the user image; calculating a face position within a three-dimensional field of view of the camera based on the calculated distance and the field of view information; and adjusting the gaze point of the user on a specific region based on the gaze direction of the user, the face position, and gaze range information.

### CROSS REFERENCE TO RELATED APPLICATION(S)

This application claims the benefit of earlier filing date and right of priority to Korean Application No. 10-2024-0195302, filed on December 24, 2024, the contents of which are all hereby incorporated by reference herein in their entirety.

### BACKGROUND

### 1. Technical Field

The technique described below is a method for detecting a gaze point.

### 2. Description of Related Art

Gaze detection technology is one of the technologies that tracks a user's gaze and identifies their gaze point. Gaze detection technology is utilized in diverse fields, including human-computer interaction (HCI), intelligent robots, medical diagnosis, and psychological analysis. Gaze detection methods generally track the user's face and eye positions and map them to specific points on the screen. Gaze detection methods can be categorized into a method that is mounted on the user’s head in the form of glasses or a headset, and a non-wearable method that tracks the user's gaze using cameras or other devices. A non-wearable method uses RGB or infrared cameras to track the user's gaze. A non-wearable method offers the advantage of greater user convenience.

### SUMMARY

Conventional gaze detection methods require a pre-use calibration process to ensure accuracy. Various calibration methods have been developed, with point-tracking-based methods being the most widely used.

However, these methods have limitations regarding the user's facial pose or movement during the calibration process and require repeated gaze at calibration points displayed on the screen. In addition, conventional point-tracking-based methods have been problematic in situations where voluntary participation is not guaranteed, such as with young children. Furthermore, these methods cannot be expected to achieve accurate gaze detection.

To overcome these challenges, methods for detecting gaze without a calibration process, such as using a saliency map, have been proposed. While these methods address several issues inherent in point-tracking-based methods, their low gaze detection accuracy makes them difficult to use in practice.

The invention described below discloses a method for detecting gaze without a correction process.

The technology described below is intended to disclose a system including an analysis device performing a gaze point detection method.

In one embodiment, the system comprises a camera, an analysis device, and a display.

In one embodiment, an analysis device comprises a processing unit; and a storage configured to store instructions that, when executed by the processing unit, cause the analysis device to perform operations that includes: acquiring user image and field of view information, wherein the user image and the field of view of view are acquired from a camera including an inertial measurement unit(IMU), wherein the inertial measurement unit recognizes a pose of the camera; estimating a gaze direction of a user based on the user image; calculating a distance between the camera and a detected face of the user based on the user image; calculating a face position within a three-dimensional field of view of the camera based on the calculated distance and the field of view information; and adjusting the gaze point of the user on a specific region based on the gaze direction of the user, the face position, and gaze range information.

In one embodiment, a gaze point detection method comprises: acquiring, by analysis device, user image and field of view information, wherein the user image and the field of view of view are acquired from a camera including an inertial measurement unit(IMU), wherein the inertial measurement unit recognizes a pose of the camera; estimating, by the analysis device, a gaze direction of a user based on the user image; calculating, by the analysis device, a distance between the camera and a detected face of the user based on the user image; calculating, by the analysis device, a face position within a three-dimensional field of view of the camera based on the calculated distance and the field of view information; and adjusting, by the analysis device, the gaze point of the user on a specific region based on the gaze direction of the user, the face position, and gaze range information.

### BRIEF DESCRIPTION OF THE DRAWINGS

FIG. 1 illustrates one embodiment of the system.

FIG. 2 illustrates one embodiment of the system.

FIG. 3 illustrates one embodiment 300 in which an analysis device implements a gaze point detection method.

FIG. 4 illustrates one embodiment of the system.

FIG. 5 illustrates one embodiment 500 of an analysis device.

### DETAILED DESCRIPTION

The technology described below is susceptible to various modifications and embodiments. Specific embodiments of the technology described below may be illustrated in the drawings of the specification. However, these are intended to illustrate the technology described below and are not intended to limit the technology described below to any specific embodiments. Therefore, it should be understood that all modifications, equivalents, or alternatives that fall within the spirit and scope of the technology described below are encompassed by the technology described below.

Terms such as "first," "second," "A," and "B" may be used to describe various components. However, these terms are used only to distinguish one component from another and are not intended to limit the components. For example, without exceeding the scope of the technology described below, the first component could be referred to as the second component, and similarly, the second component could also be referred to as the first component. The term “and/or” includes any combination of multiple related listed items or any one of multiple related listed items.

In the terms used hereinafter, singular expressions should be understood to include plural expressions unless the context clearly dictates otherwise, and terms such as "comprises" should be understood to mean the presence of a described feature, number, step, operation, component, part, or combination thereof, but not to exclude the possibility of the presence or addition of one or more other features, numbers, steps, operations, components, parts, or combinations thereof.

Before proceeding with a detailed description of the drawings, it should be clarified that the division of components in this specification is merely based on the primary function each component is responsible for. In other words, two or more components described below may be combined into a single component, or a single component may be further subdivided into two or more components with more specific functions. In addition to the main function that each component is responsible for, each component described below may additionally perform some or all of the functions that other components are responsible for, and of course, some of the main functions that each component is responsible for may be performed exclusively by other components.

Additionally, in performing a method or method of operation, each process constituting the method may occur in a different order than the stated order, unless the context clearly indicates a specific order. That is, each process may occur in the same order as the stated order, may be performed substantially simultaneously, or may be performed in the opposite order.

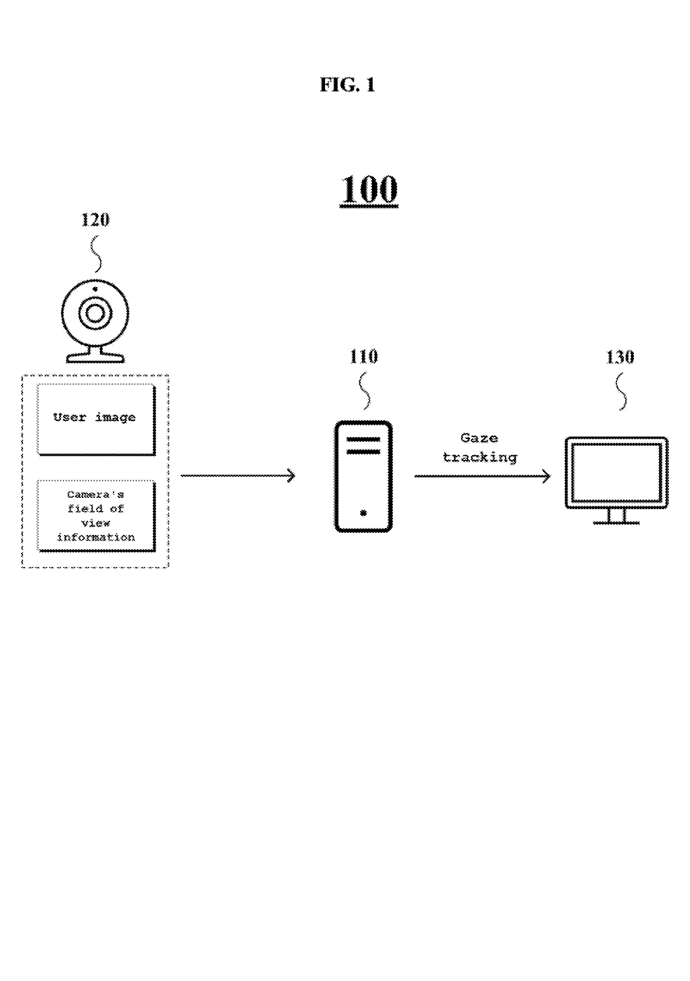

FIG. 1 illustrates one embodiment of the system.

The system may include an analysis device 110, a camera 120, and a display 130.

The analysis device 110 may be physically implemented in various forms. For example, the analysis device 110 may take the form of a PC, laptop, smart device, server, or data processing chipset.

There may be at least one analysis device 110. That is, the gaze point detection method may be performed by a single analysis device or may be performed separately by at least one device.

The camera 120 may collect a user image. The user image may be a image/video taken of the user. The camera 120 may collect information on the camera's field of view. The camera's field of view information may include information about the range within which the camera views the user.

The display 130 may be a device that a user looks at. The display 130 may be a device where the user’s gaze is located. The display 130 may be a device that outputs the results of gaze tracking.

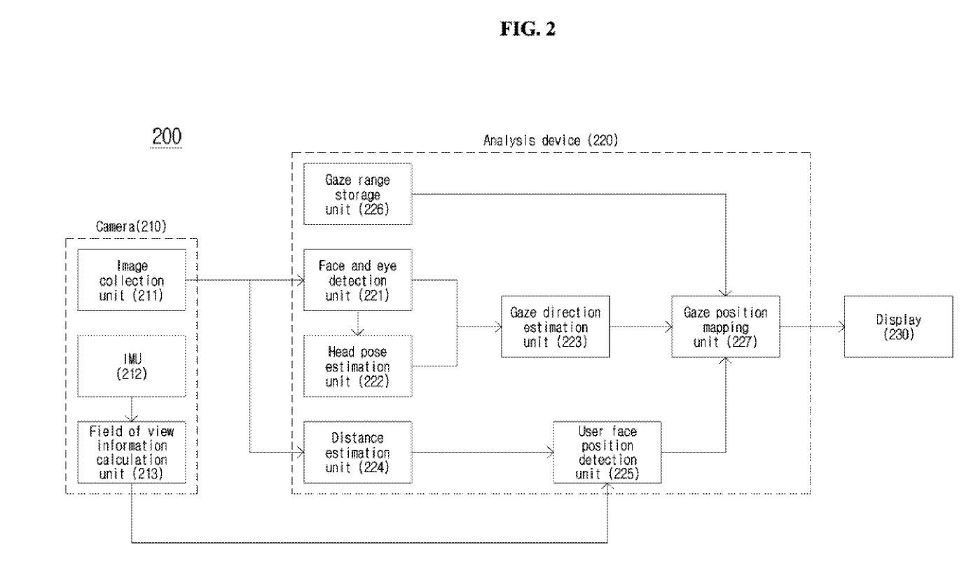

FIG. 2 illustrates one embodiment of the system.

The camera 210 may be positioned to capture the image of the user. The camera 210 may be fixed to the display 230. The camera 210 may be fixed above the display 230.

The camera 210 may include an image collection unit 211, an inertial measurement unit 212 (Inertial Measurement Unit, IMU), and a field of view information calculation unit 213.

The image collection unit 211 may collect various types of images. The image collection unit 211 may include at least one of an RGB (Red-Green-Blue) sensor, an NIR (Near-Infrared) sensor, or an RGB-D (RGB-Depth) sensor.

The image collection unit 211 may collect images. The image collection unit may collect images of the user. The image collection unit 211 may collect images including the user's face and eyes. The image collection unit 211 may collect images with sufficient resolution to enable gaze detection even under various lighting conditions, along with a frame rate above a certain level.

The inertial measurement unit 212 may be mounted on the camera 210. The inertial measurement unit 212 may be connected to the camera 210.

The inertial measurement unit 212 may be a sensor that measures inertia to measure the angle at which an object is tilted. The inertial measurement unit 212 may be a sensor that recognizes the pose of the camera 210. The inertial measurement unit 212 may be a sensor that measures the angle at which the camera 210 is tilted, etc. The inertial measurement unit 212 may be a sensor that measures the angle at which the camera 210 is currently shooting. In summary, the inertial measurement unit 212 may be a sensor that recognizes the pose of the camera 210 by measuring the direction in which the camera 210 is looking.

The field of view information calculation unit 213 may estimate the pose of the camera 210 based on data measured by the inertial measurement unit 212. The field of view information calculation unit 213 may calculate the FOV (Field of View) of the camera 210 based on the pose of the camera 210 and various parameters of the camera 210. That is, the field of view information of the camera 210 may include the FOV of the camera 210. The parameters of the camera 210 may include the size and resolution of the camera 210 sensor, the ratio of the lens, etc.

The analysis device may include a face and eye detection unit 221, a head pose estimation unit 222, a gaze direction estimation unit 223, a distance estimation unit 224, a user face position detection unit 225, a gaze range storage unit 226, and a gaze position mapping unit 227.

The face and eye detection unit 221 may detect a face region and an eye region from an image collected by a camera 210. The face region and eye region may be regions in the image where the face and eyes are expressed.

The face and eye detection unit 221 may detect the face region and the eye region from the image acquired by the camera 210 using a detection model. The detection model may be a machine learning (ML)-based model. The detection model may be an artificial neural network (ANN)-based model. The detection model may be a convolutional neural network (CNN)-based model or a multi-task cascaded convolutional network (MTCNN)-based model.

The head pose estimation unit 222 may estimate a head pose of the user based on the image captured by the camera 210. The head pose estimation unit 222 may estimate the head pose based on facial landmarks.

The head pose estimation unit 222 may estimate the head pose based on a head pose estimation model. Similar to the detection model, the head pose estimation model may be a machine learning-based model. The head pose estimation model may be a CNN, ResNet, or VGG (Visual Geometry Group) model, or the like.

The gaze direction estimation unit 223 may estimate a gaze direction of a person. The gaze direction estimation unit 223 may accurately estimate the gaze direction of the person even when given various people's faces or various lighting conditions.

The gaze direction estimation unit 223 may estimate the gaze direction based on the face region, eye region, and head pose.

The gaze direction estimation unit 223 models a human face in 3D based on the face region, eye region, and head pose, and then estimates the gaze direction based on the 3D modeling results. The gaze direction estimation unit 223 may predict the gaze direction by calculating eye landmarks and pupil positions based on the face region, eye region, and head pose.

The gaze direction estimation unit 223 may estimate the gaze direction using a gaze direction estimation model. Similar to the detection model, the estimated gaze direction may be a machine learning-based model.

The distance estimation unit 224 may estimate the distance between the camera 210 and the detected user’s face. The distance estimation unit 224 may estimate the distance between the camera 210 and the user’s face based on the image acquired by the camera 210. In one embodiment, the distance estimation unit 224 may calculate the distance to the detected face using various methods such as depth information of an RGB-D camera, a stereo camera, or a distance sensor. Using RGB-D camera may be simpler in terms of hardware. Alternatively, the distance estimation unit 224 may estimate the distance between the camera 210 and the user’s face from the image acquired by the camera 210 using a distance estimation model. The distance estimation model may be a machine learning-based model, similar to the detection model.

The user face position detection unit 225 detects the position of the user's face. The user face position detection unit 225 detects the position of the user's face in the coordinate system of the camera 210. The user face position detection unit 225 detects the position of the user's face in the field of view of the camera 210. The user face position detection unit 225 may detect the three-dimensional position of the user's face in the coordinate system of the FoV of the camera 210.

The gaze range storage unit 226 may store and manage information about the gaze range. The gaze range storage unit 226 may store and manage information about the screen or specific region (gaze range) on which the user's gaze may be focused on the display 230. The gaze range storage unit 226 may store and manage the range in which the gaze point is detected in the user's view on the display 230. The gaze range input unit may store and manage gaze range mapping information regarding the size of the display 230, etc., to convert the user's gaze on the display 230 into specific coordinates on the display 230.

The gaze position mapping unit 227 may convert and map the user's gaze to specific coordinates on the display 230. The gaze position mapping unit 227 may convert and map the user's gaze to specific coordinates on the display 230 based on the gaze direction estimated by the gaze direction estimation unit 223, the user's face position detected by the user face position detection unit 225, and the gaze range stored and managed by the gaze range storage unit 226. In one embodiment, the user face position detection unit 225 may reduce the error between the specific coordinates the user is looking at and the actual estimated coordinates through an adjustment algorithm based on 3D face position information, thereby enabling more accurate mapping of the gaze point.

The display 230 may output the results mapped by the gaze position mapping unit 227. The display 230 may output the results of the gaze point analysis mapped by the gaze position mapping unit 227 on the screen.

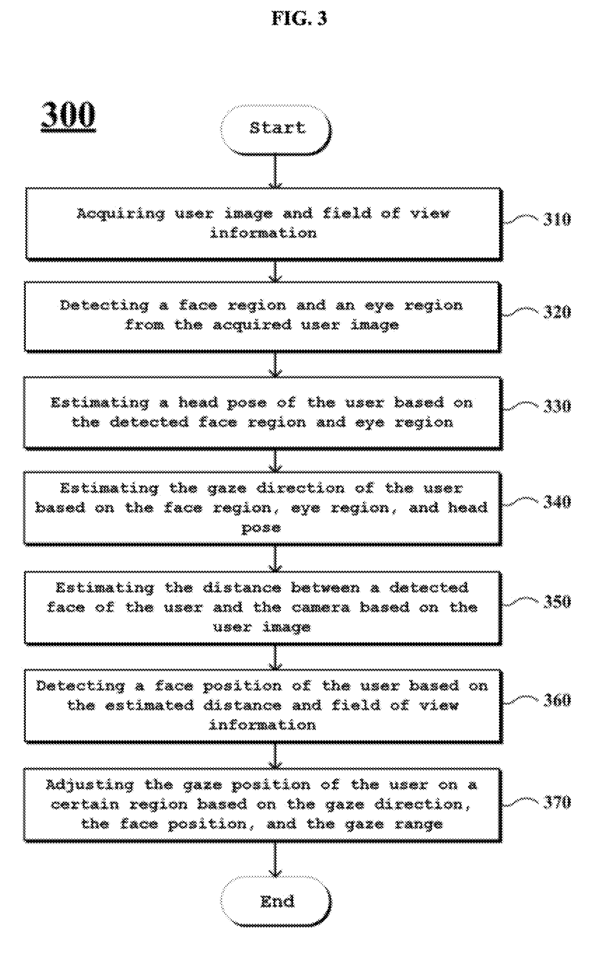

FIG. 3 illustrates one embodiment 300 in which an analysis device implements a gaze point detection method. In the embodiment of FIG. 3, the analysis device may be the analysis device disclosed in FIG. 2, etc.

The analysis device may acquire user image and field of view information 310. The user image and field of view information may be transmitted from a camera. The camera may be equipped with an inertial measurement unit.

The analysis device may detect a face region and an eye region from the acquired user image 320.

Based on the detected face region and eye region, the analysis device may estimate a head pose of the user 330.

Based on the face region, eye region, and head pose, the analysis device may estimate the gaze direction of the user 340.

The analysis device may estimate the distance between a detected face of the user and the camera based on the user image 350.

The analysis device may detect a face position of the user based on the estimated distance and field of view information 360. The analysis device may store information about the gaze range.

The analysis device may adjust the gaze position of the user on a certain region(e.g. the display) based on the gaze direction, the face position, and the gaze range 370.

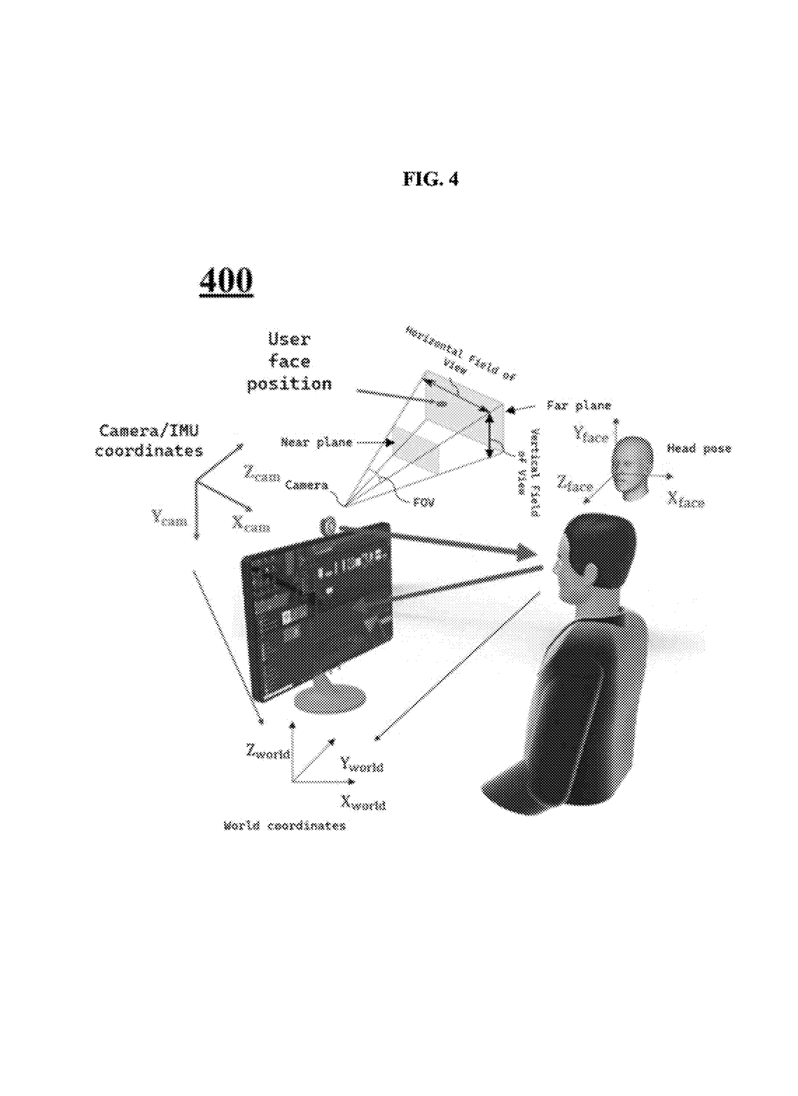

FIG. 4 illustrates one embodiment of the system.

As shown in FIG. 4, in the gaze point detection method, camera pose-based coordinates, world coordinates, and head pose coordinates may be used. The gaze point detection method may utilize a general gaze coordinate system that takes into account the head pose of the user. Furthermore, gaze point detection methods may utilize the relationship between gaze points mapped onto the screen coordinate system, which is the gaze range, through geometric adjustment that considers the face position within the three-dimensional space of the camera's FoV. Geometric adjustment may consider the camera's pose and the center position of the camera FoV, and may improve performance by simply adjusting the distortion of the gaze point coordinates according to the up/down/left/right positions of the detected face. Additionally, performance improvement is possible through deep learning models that utilize data collected from various locations on the camera FoV.

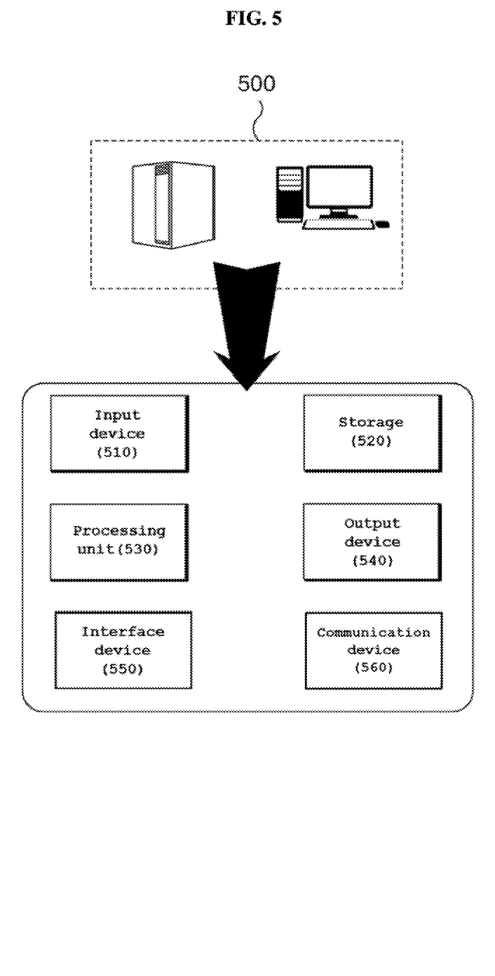

FIG. 5 illustrates one embodiment 500 of an analysis device.

The analysis device 500 may correspond to the analysis device 100 described above in FIG. 1. That is, the analysis device 500 may be a device that performs the above-mentioned gaze point detection method. The analysis device 500 may include at least one input device 510, a storage 520, a processing unit 530, an output device 540, an interface device 550, and a communication device 560.

The input device 510 may receive data, information, or models necessary for performing the above-mentioned gaze point detection method. The input device 510 may receive user images, field of view information, gaze range information, user gaze direction information, distance information from the user, and user face position information. The input device 510 may receive a detection model, a gaze direction estimation model, and a distance estimation model. The input device 510 may receive training data required to train the detection model, the gaze direction estimation model, and the distance estimation model. The input device 510 may include a device (keyboard, mouse, touch screen, joystick, trackball, touchpad, etc.) for inputting a certain command or data. The input device 510 may also include a configuration for receiving data through a separate storage device (USB, CD, hard disk, etc.). The input device 510 may receive data through a separate measuring device (sensor, microphone, camera, scanner, etc.) or a separate database. The input device 510 may also receive data through a communication device 560 via wired or wireless means. The input device 510 may also receive a control signal for controlling the analysis device 500.

The storage 520 may store data, information, or models necessary for performing the above-mentioned gaze point detection method. The storage 520 may store user image, field of view information, gaze range information, user gaze direction information, distance information from the user, and user face position information. The storage 520 may store a detection model, a gaze direction estimation model, and a distance estimation model. The storage 520 may store training data required to train a detection model, a gaze direction estimation model, and a distance estimation model. The storage 520 may also be a device that stores certain data, information, or models. The storage 520 may store data, information, models, etc. input through the input device 510. The storage 520 may store instructions that cause the processing unit 530 to perform operations required for a gaze point detection method. The storage 520 may store information generated during the operation of the processing unit 530. That is, the storage 520 may include memory. For example, the storage may include a hard disk drive (HDD), a solid state drive (SSD), a ROM, a RAM, a CD-ROM, a magnetic tape, or a floppy disk.

The processing unit 530 may perform the calculations necessary to perform the above-mentioned gaze point detection method. The processing unit 530 may perform the calculations necessary for the analysis device to acquire user image and field of view information. The processing unit 530 may perform the calculations necessary for the analysis device to estimate a gaze direction of a user based on the user image. The processing unit 530 may perform the calculations necessary for the analysis device to calculate a distance between the camera and a detected face of the user based on the user image. The processing unit 530 may perform the calculations necessary for the analysis device to calculate a face position within a three-dimensional field of view of the camera based on the calculated distance and the field of view information. The processing unit 530 may perform the calculations necessary for the analysis device to adjust the gaze point of the user on a specific region based on the gaze direction of the user, the face position, and gaze range information. The processing unit 530 may be a device such as a processor, an application processor (AP), or a chip embedded with a program that processes data and performs certain operations. For example, the processing unit 530 may include a central processing unit (CPU), a graphics processing unit (GPU), or a neural processing unit (NPU). The processing unit 530 may generate a control signal that controls the analysis device 500. The processing unit 530 may generate a control signal that controls the input device 510, the storage 520, the output device 540, the interface device 550, and the communication device 560 included in the analysis device 500.

The output device 540 may be a device that outputs certain data, information, and models. The output device 540 may be a device that outputs certain data, information, and models to the outside of the analysis device 500. The output device 540 may also output interfaces, input data, analysis results, etc. required for the data processing process. The output device 540 may also include a device that outputs data, etc. through tactile, visual, auditory, gustatory, and olfactory methods. The output device 540 may be physically implemented in various forms, such as a display, speaker, vibration motor, or document output device. The output device 540 may output data, information, or models stored in the storage 520. The output device 540 may output data, information, models, etc. generated during the operation of the processing unit 530. The output device 540 may output the results of the operation of the processing unit 530.

The interface device 550 may be a device that receives certain commands and data from the outside. The interface device 550 may receive a control signal for controlling the analysis device 500. The interface device 550 may output the results analyzed by the analysis device 500. The interface device 550 may receive information necessary for performing the above-mentioned gaze point detection method from a physically connected input device or an external storage.

The communication device 560 may receive information necessary for performing the above-mentioned gaze point detection method. The communication device 560 may receive a model necessary for performing the above-mentioned gaze point detection method. The communication device 560 may transmit and receive user image, field of view information, gaze range information, user gaze direction information, distance information from the user, and user face position information. The communication device 560 may transmit and receive a detection model, a gaze direction estimation model, and a distance estimation model. The communication device 560 may receive a control signal required to control the analysis device 500. The communication device 560 may transmit the results analyzed by the analysis device 500. The communication device 560 may refer to a configuration that receives and transmits certain data, information, models, etc. through a wired or wireless network. The communication device 560 may perform network communication such as Wi-Fi (Wireless Fidelity), Wi-Fi Direct, Bluetooth, UWB (Ultra-Wide Band), NFC (Near Field Communication), USB (Universal Serial Bus), HDMI (High Definition Multimedia Interface), LAN (Local Area Network), etc.

The above-mentioned gaze point detection method can be implemented as a program (or application) containing an executable algorithm that can be executed on a computer.

The program can be stored and provided on a non-transitory computer-readable medium.

The above-mentioned temporarily readable medium refers to various RAMs such as static RAM (SRAM), dynamic RAM (DRAM), synchronous DRAM (SDRAM), double data rate SDRAM (DDR SDRAM), enhanced SDRAM (ESDRAM), synchronous DRAM (Synclink DRAM, SLDRAM), and direct Rambus RAM (DRRAM).

The above non-transitory readable medium refers to a medium that stores data semi-permanently and can be read by a device, rather than a medium that stores data for a short period of time, such as a register, cache, or memory. Specifically, the various applications or programs described above may be stored and provided in a non-transitory readable medium, such as a CD, DVD, hard disk, Blu-ray disk, USB, memory card, ROM (read-only memory), PROM (programmable read only memory), EPROM (Erasable PROM, EPROM), EEPROM (Electrically EPROM), or flash memory.

The present embodiment and the drawings attached to the present specification only clearly illustrate a part of the technical idea included in the above-described technology, and it will be obvious that all modified examples and specific embodiments that can be easily inferred by a person skilled in the art within the scope of the technical idea included in the specification and drawings of the above-described technology are included in the scope of the rights of the above-described technology.

What is claimed is:

1. A gaze point detection method, comprising:
acquiring, by analysis device, user image and field of view information,
wherein the user image and the field of view information are acquired from a camera including an inertial measurement unit(IMU),
wherein the inertial measurement unit recognizes a pose of the camera;
estimating, by the analysis device, a gaze direction of a user based on the user image;
calculating, by the analysis device, a distance between the camera and a detected face of the user based on the user image;
calculating, by the analysis device, a face position within a three-dimensional field of view of the camera based on the calculated distance and the field of view information; and
adjusting, by the analysis device, the gaze point of the user on a specific region based on the gaze direction of the user, the face position, and gaze range information.

2. The gaze point detection method of claim 1, wherein the user image and the field of view information are information acquired from a camera, and
wherein the camera further includes an image collection unit, and a field of view information calculation unit.

3. The gaze point detection method of claim 1, wherein the inertial measurement unit measures the angle at which the camera is panned and tilted to recognize the pose of the camera.

4. The gaze point detection method of claim 2, wherein the image collection unit includes at least one of an RGB (Red-Green-Blue) sensor, an NIR (Near-Infrared) sensor, or an RGB-D (RGB-Depth) sensor.

5. The gaze point detection method of claim 2, wherein the field of view information calculation unit calculates the three-dimensional field of view of the camera based on a pose of the camera recognized by the inertial measurement unit and parameters of the camera.

6. The gaze point detection method of claim 1, wherein estimating the gaze direction of the user includes detecting a face region and an eye region of the user in the user image, estimating a head pose of the user based on the face region and the eye region, and estimating the gaze direction of the user based on the face region, the eye region, and the head pose.

7. An analysis device, comprising:
a processing unit; and
a storage configured to store instructions that, when executed by the processing unit, cause the analysis device to perform operations that includes:
acquiring user image and field of view information,
wherein the user image and the field of view information are acquired from a camera including an inertial measurement unit(IMU),
wherein the inertial measurement unit recognizes a pose of the camera;
estimating a gaze direction of a user based on the user image;
calculating a distance between the camera and a detected face of the user based on the user image;
calculating a face position within a three-dimensional field of view of the camera based on the calculated distance and the field of view information; and
adjusting the gaze point of the user on a specific region based on the gaze direction of the user, the face position, and gaze range information.

8. The analysis device of claim 7, wherein the user image and the field of view information are information acquired from a camera, and
wherein the camera further includes an image collection unit, and a field of view information calculation unit.

9. The analysis device of claim 7, wherein the inertial measurement unit measures the angle at which the camera is panned and tilted to recognize the pose of the camera.

10. The analysis device of claim 8, wherein the image collection unit includes at least one of an RGB (Red-Green-Blue) sensor, an NIR (Near-Infrared) sensor, or an RGB-D (RGB-Depth) sensor.

11. The analysis device of claim 8, wherein the field of view information calculation unit calculates the three-dimensional field of view of the camera based on a pose of the camera measured by the inertial measurement unit and parameters of the camera.

12. The analysis device of claim 7, wherein estimating the gaze direction of the user includes detecting a face region and an eye region of the user in the user image, estimating a head pose of the user based on the face region and eye region, and estimating gaze direction of the user based on the face region, the eye region, and the head pose.

13. A system comprising a camera, an analysis device, and a display,
wherein the camera includes an inertial measurement unit, an image collection unit, and a field of view information calculation unit,
wherein the analysis device is a device that performs the gaze point detection method described in claim 1,
wherein the display is a device that outputs the gaze tracking results of the analysis device,
wherein the inertial measurement unit recognizes a pose of the camera,
wherein the image collection unit collects user image and transmits the user image to the analysis device, and
wherein the field of view information calculation unit calculates the field of view information based on the pose of the camera recognized by the inertial measurement unit and parameters of the camera.
